(19) United States
(12) Patent Application Publication
(10) Pub. No.: US 2007/0027991 A1
(43) Pub. Date: Feb. 1, 2007

(54) TCP isolation with semantic processor TCP state machine

(75) Inventors: Somsubhra Sikdar, San Jose, CA (US); Kevin Jerome Rowett, Cupertino, CA (US); Caveh Jalali, Redwood City, CA (US); Prasad Rajendra Rallapalli, San Jose, CA (US)

Correspondence Address: MARGER JOHNSON & MCCOLLOM, P.C., 210 SW MORRISON STREET, SUITE 400, PORTLAND, OR, 97204, US

(73) Assignee: Mistletoe Technologies, Inc., Cupertino, CA (US)

(21) Appl. No.: 11/181,528

(22) Filed: Jul. 14, 2005

(51) Int. Cl. H04L 12/56

(52) U.S. Cl. 709/227; 370/401

(57) ABSTRACT

A system and method for isolating TCP comprises a proxy configured to manage a plurality of sessions including at least one transmission control protocol session, wherein the proxy translates data between the transmission control protocol session and a local session.

### REFERENCE TO RELATED APPLICATIONS

Copending U.S. patent application Ser. No. 10/351,030, titled “Reconfigurable Semantic Processor,” filed by Somsubhra Sikdar on Jan. 24, 2003, is incorporated herein by reference.

### FIELD OF THE INVENTION

This invention relates generally to data communications, and more specifically to methods and apparatus for isolating transmission control protocol (TCP) sessions.

### BACKGROUND OF THE INVENTION

In the data communications field, networking devices such as servers typically use packets when communicating over a network. A packet is a finite-length (generally several tens to several thousands of octets) digital transmission unit comprising one or more header fields and a data field. The data field may contain virtually any type of digital data. The header fields convey information (in different formats depending on the type of header and options) related to delivery and interpretation of the packet contents. This information may, e.g., identify the packet's source or destination, identify the protocol to be used to interpret the packet, identify the packet's place in a sequence of packets, provide an error correction checksum, or aid packet flow control. The finite length of a packet can vary based on the type of network that the packet is to be transmitted through and the type of application used to present the data.

Typically, packet headers and their functions are arranged in an orderly fashion according to the open-systems interconnection (OSI) reference model. This model partitions packet communications functions into layers, each layer performing specific functions in a manner that can be largely independent of the functions of the other layers. For instance, a network layer, typically implemented with the well-known Internet Protocol (IP), provides network-wide packet delivery and switching functionality, while a higher-level transport layer can provide mechanisms for end-to-end delivery of packets. As such, each layer can prepend its own header to a packet, and regard all higher-layer headers as merely part of the data to be transmitted.

Transmission Control Protocol (TCP) is a transport layer used to provide mechanisms for highly-reliable end-to-end delivery of packet streams during an established TCP session. Traditionally, the establishment of a TCP session requires a three-way handshake between communicating endpoints. This three-way handshaking allows TCP endpoints to exchange socket information uniquely identifying the TCP session to be established, and to exchange initial sequence numbers and window sizes used in the packet sequencing, error recovery, and flow control. An example of a typical three-way handshake may include a first TCP endpoint sending a synchronize SYN packet to a second TCP endpoint, the second TCP endpoint responding with a synchronize and acknowledgment SYN-ACK packet, and the first TCP endpoint sending an acknowledgement ACK packet in response to the SYN-ACK packet. TCP further requires a similar exchange of termination FIN packets and acknowledgments to the FIN packets when closing an existing TCP session. Thus to use TCP in data exchanges, TCP endpoints must be able maintain information regarding the state of each of its TCP sessions, e.g., opening a TCP session, waiting for acknowledgment, exchanging data, or closing a TCP session.

A commonly exploited weakness of TCP stems from this maintenance of state information. For instance, in a SYN flood denial-of-service attack, multiple SYN packets are received by a TCP endpoint, each requesting the establishment of a different TCP session. The initiator of the attack, however, does not have any intention of completing the corresponding three-way handshakes, often times providing a fictitious source port to ensure their failure. Responding to this flood of SYN packets allocates the TCP endpoint's limited processing resources by requiring it maintain state information for each session opening while waiting for acknowledgments that will never arrive. Another attack that misallocates processing resources involves receiving packets for a session that conflict with the maintained state information, e.g., sending a SYN packet in an already established session or a FIN packet for a session that has not been established.

Once a TCP session is properly established, TCP endpoints may exchange data in a TCP packet stream. Since packets may be lost, or arrive out-of-order during transmission, TCP provides mechanisms to retransmit lost or late packets and reorder the packet stream upon arrival including discarding duplicate packets. TCP endpoints may also be required to perform other exception processing prior to the TCP reordering, such as reassembling lower-layer fragmented packets, e.g, IP fragments, and/or performing cryptography operations, e.g., according to an Internet Protocol Security (IPSec) header(s). Thus use of TCP to reliably exchange packet streams comes at a cost of efficiency in TCP endpoint processing and increased vulnerability to TCP-based attacks. Accordingly, a need remains for an improved system and method for communicating over a network using TCP.

### DESCRIPTION OF THE DRAWINGS

The invention may be best understood by reading the disclosure with reference to the drawings, wherein:

FIG. 1 illustrates, in block form, a network communications system useful with embodiments of the present invention;

FIG. 2A illustrates, in block form, embodiments of the proxy shown in FIG. 1;

FIG. 2B shows, in block form, an example packet flow through proxy 200 shown in FIGS. 1 and 2A;

FIG. 3 shows an example flow chart illustrating embodiments for operating the proxy shown in FIGS. 1, 2A, and 2B;

FIG. 4 illustrates, in block form, a semantic processor useful with embodiments of the network-interface proxy and device-interface proxy shown in FIGS. 2A and 2B; and

FIG. 5 shows an example flow chart illustrating embodiments for operating the semantic processor shown in FIG. 4 as a TCP state machine.

### DETAILED DESCRIPTION

Direct network communication using Transmission Control Protocol (TCP) may increase a networking device's vulnerability to TCP-based attacks and require additional processing of packets upon arrival. The addition of a proxy TCP endpoint designed to specifically perform the direct TCP-based network communications, shields networking devices from potential attacks and increases their processing efficiency. Embodiments of the present invention will now be described in more detail.

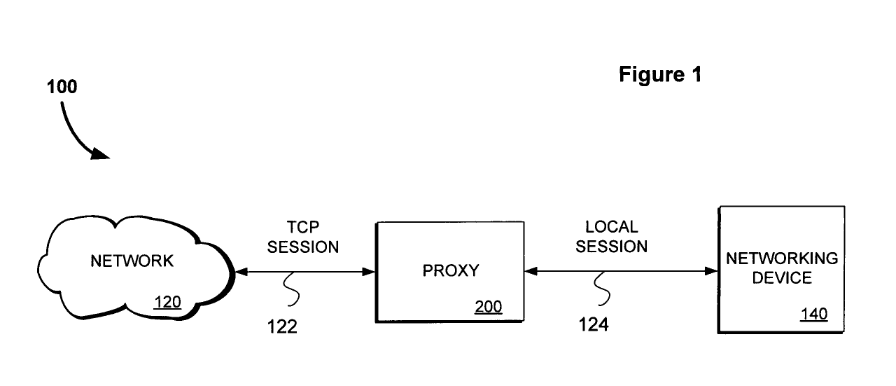

FIG. 1 illustrates, in block form, a network communications system 100 useful with embodiments of the present invention. Referring to FIG. 1, the network communications system 100 includes a networking device 140 that communicates over a network 120 via a proxy 200. The network 120 may be any Wide Area Network (WAN) that provides packet switching. The networking device 140 may be a server or any other device capable of network communications.

The proxy 200 maintains at least one TCP session over the network 120 and a corresponding local session with the networking device 140. In some embodiments, the local session may be a TCP session established with the networking device 140 through a private network, e.g., a company enterprise network, Internet Service Provider (ISP) network, home network, etc. The proxy 200 functions as a network communications intermediary for networking device 140 by translating data between the local and TCP sessions. For instance, when receiving packetized data from the network 120 in a TCP session, the proxy 200 may sequence and depacketize the data prior to providing it to the networking device 140 in the local session. The depacketization may include reassembling Internet Protocol (IP) fragments, and/or performing cryptography operations, e.g., according to the Internet Protocol Security (IPSec) header(s). This sequencing and processing by proxy 200 allows the networking device 140 to receive a uniform data stream in the local session, ensuring quality-of-service (QOS) for the networking device 140 and control over network bandwidth usage.

Since the proxy 200 is the endpoint for the network communications, not networking device 140, the TCP session has a TCP signature of the proxy 200, thus concealing the identity of the networking device 140 from the network 120. This concealment of the networking device 140 limits its exposure to network-based attacks. The proxy 200 may perform Network Address Translation (NAT) of destination and source IP addresses to help hide the identity of the networking device 140. The proxy 200 may be implemented at any network interface, such as a firewall.

In some embodiments, proxy 200 may provide network communication and processing for multiple networking devices 140. In these embodiments, the management of network communication at a single network interface point may allow proxy 200 to provide additional functionality for increasing the efficiency of the network management and packet processing. For instance, when the proxy 200 discovers network changes, e.g., next hop change, Internet Control Message Protocol (ICMP) fragments, packet loss, etc., in one of the TCP sessions, the changes may be applied to all of the TCP sessions. This becomes especially powerful when combined with the full neighbor implementation of Border Gateway Protocol (BGP) or other link state routing protocol that is aware of the entire topology of network 120. Additionally, since the proxy 200 maintains multiple sessions, the status and statistics of these sessions can be accessed at a single network interface point.

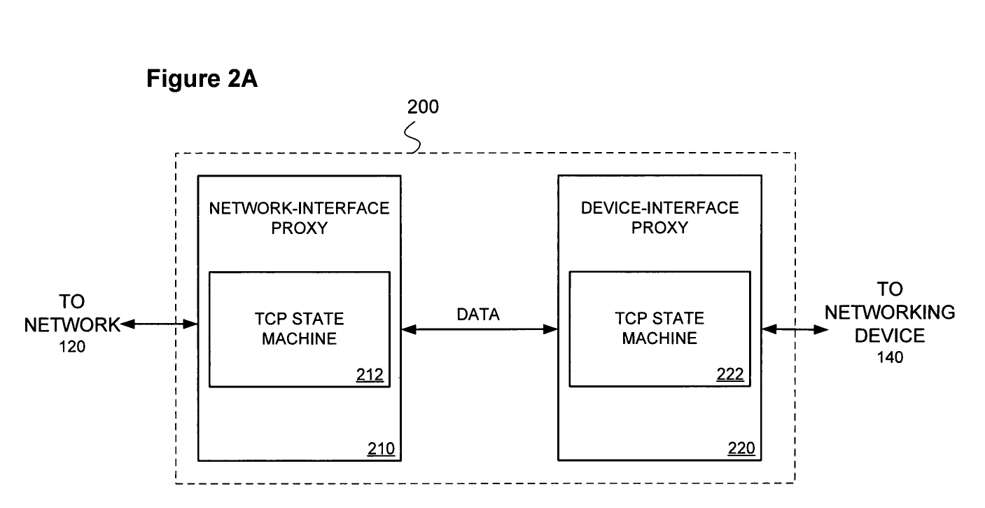

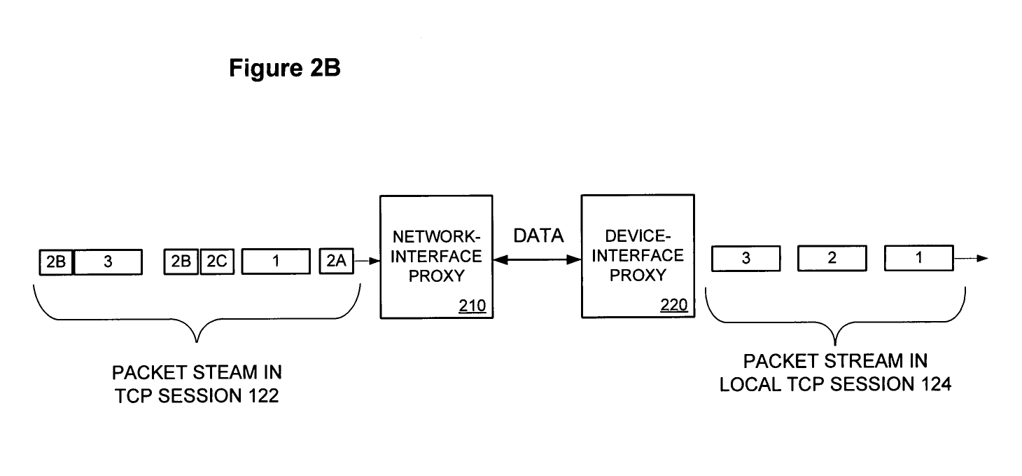

The structure and operation of proxy 200 for some embodiments of the invention will be explained with reference to FIGS. 2A-4. FIG. 2A illustrates, in block form, embodiments of the proxy 200 shown in FIG. 1. Referring to FIG. 2A, the proxy 200 includes a network-interface proxy 210 to manage one or more TCP sessions over the network 120 and a device-interface proxy 220 to manage one or more local sessions with networking device 140. The network-interface proxy 210 and device-interface proxy 220 exchange data to be transmitted over their respective sessions. For instance, when network-interface proxy 210 provides payload data from the TCP session to device-interface proxy 220, the device-interface proxy 220 transmits the data to the networking device 140 in the local session. Alternatively, when device-interface proxy 220 provides payload data from networking device 140 to network-interface proxy 210, the network-interface proxy 210 transmits the data over the network 120 in the TCP session.

The network-interface proxy 210 includes a TCP state machine 212 to establish and manage the TCP sessions over the network 120, including maintaining state information for each TCP session and implementing packet sequencing, error recovery and flow control mechanisms. The TCP state machine 212 sequences and processes packet streams received over the TCP sessions and provides the sequenced payload data to the device-interface proxy 220. Because TCP state machine 212 previously sequenced and processed the payload data, the device-interface proxy 220 is then capable of providing a uniform data stream to networking device 140 in the local session. The TCP state machine 212 further packetizes payload data received from device-interface proxy 220 and transmits it over the corresponding TCP session.

The device-interface proxy 220 may include a TCP state machine 222 to establish and manage local TCP sessions with the networking device 140. TCP state machine 222 operates similarly to TCP state machine 212 with respect to packet streams over the local TCP sessions.

FIG. 2B shows, in block form, an example packet flow through proxy 200 shown in FIGS. 1 and 2A. Referring to FIG. 2B, the network-interface proxy 210 receives a packet stream in TCP session 122. In this example embodiment, the packet stream includes three TCP data payloads 1, 2A, 2B, 2C, and 3, which may arrive at network-interface proxy 210 at varying rates, out-of-order, IP fragmented, e.g., payload 2 fragmented into 2A, 2B and 2C, and duplicated. The network-interface proxy 210 reassembles the fragmented packets (fragments 2A, 2B, and 2C into TCP payload 2), reorders the TCP payloads, and discards the duplicated packets upon their arrival. The in-order and reassembled TCP payload data is then provided to the device-interface proxy 220, where it is transmitted in the local TCP session 124 at a uniform rate. The network-interface proxy 210 may also perform cryptography operations upon the TCP packets prior to the reassembly and reordering, when they are received in need of decryption and/or authentication. This processing and uniform transmission by the proxy 200 allows a networking device 140 to receive a uniform in-order packet stream, thus reducing its processing burden.

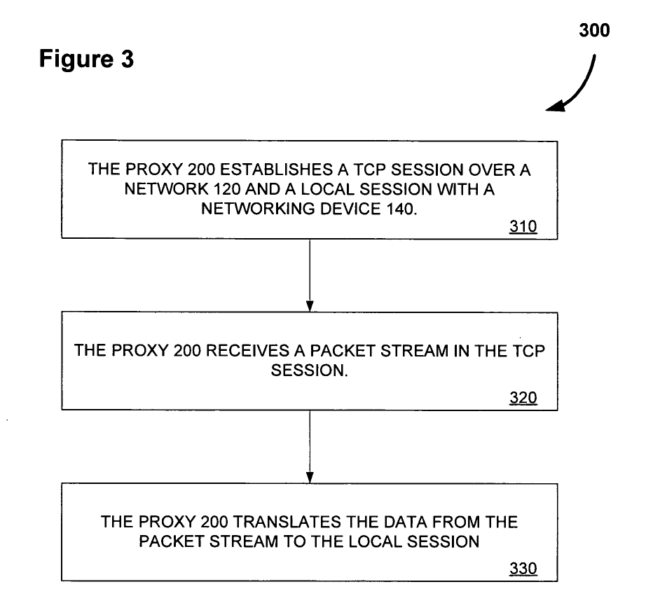

FIG. 3 shows an example flow chart 300 illustrating embodiments for operating the proxy 200 shown in FIGS. 1, 2A, and 2B. According to a block 310, the proxy 200 establishes a TCP session over the network 120 and a local session with a networking device 140. The proxy 200 may establish the TCP session 122 through a three-way handshake with a remote TCP endpoint. The proxy 200 may then establish a local session 124 with the networking device 140 responsive to the remote TCP session 122 establishment. The local session 124 may be established concurrently with the establishment of the TCP session 122 to decrease data exchange latency, or it may be established after the TCP session 122 to avoid problems with SYN floods and other TCP-based attacks. In some embodiments, the local session 124 is also a TCP session established with a three-way handshake between the proxy 200 and the networking device 140.

According to a next block 320, the proxy 200 receives a packet stream in the TCP session 122 over the network 120. The proxy 200 manages the TCP session 122 by providing error recovery for lost or late packets and flow rate control by adjusting the size of the TCP window.

According to a next block 330, the proxy 200 translates data from the packet stream to the local session 124. The translation includes sequencing and depacketizing the data, e.g., with the network-interface proxy 210, and providing the data to the networking device 140 in the local session 124. The sequencing may include reordering of those packets received out-of-order and discarding duplicated packets, while the depacketization may include any additional processing that may be required, such as reassembly of IP fragmented packets and/or performance of cryptography operations according to IPSec headers. Although the flowchart 300 shows data transfers from the network 120 to the networking device 140, proxy 200 may also provide data in the opposite direction. The proxy 200 provides operations that are not typically provided in firewalls. However, the proxy 200 can also include, in addition to the TCP proxy operations, other conventional firewall operations

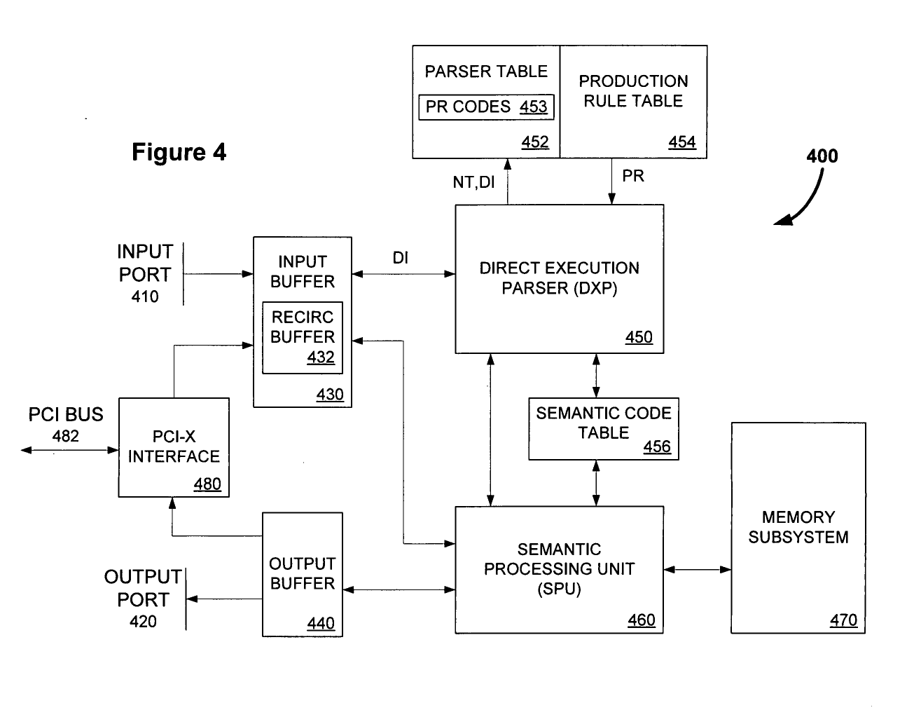

FIG. 4 illustrates, in block form, a semantic processor 400 useful with embodiments of the network-interface proxy 210 and device-interface proxy 220 shown in FIGS. 2A and 2B. Referring to FIG. 4, a semantic processor 400 contains an input buffer 430 for buffering data streams received through the input port 410, and an output buffer 440 for buffering data steams to be transmitted through output port 420. Input 410 and output port 420 may comprise a physical interface to network 120 (FIGS. 1 and 2), e.g., an optical, electrical, or radio frequency driver/receiver pair for an Ethernet, Fibre Channel, 802.11x, Universal Serial Bus, Firewire, SONET, or other physical layer interface.

A PCI-X interface 480 is coupled to the input buffer 430, the output buffer 440, and an external PCI bus 482. The PCI bus 482 can connect to other PCI-capable components, such as disk drives, interfaces for additional network ports, other semantic processors, etc. The PCI-X interface 480 provides data streams or packets to input buffer 430 from PCI bus 482 and transmits data streams packets over PCI bus 482 from output buffer 440.

Semantic processor 400 includes a direct execution parser (DXP) 450 that controls the processing of packets in the input buffer 430 and a semantic processing unit (SPU) 460 for processing segments of the packets or for performing other operations. The DXP 450 maintains an internal parser stack (not shown) of non-terminal (and possibly also terminal) symbols, based on parsing of the current input frame or packet up to the current input symbol. When the symbol (or symbols) at the top of the parser stack is a terminal symbol, DXP 450 compares data DI at the head of the input stream to the terminal symbol and expects a match in order to continue. When the symbol at the top of the parser stack is a non-terminal (NT) symbol, DXP 450 uses the non-terminal symbol NT and current input data DI to expand the grammar production on the stack. As parsing continues, DXP 450 instructs a SPU 460 to process segments of the input, or perform other operations.

Semantic processor 400 uses at least three tables. Code segments for SPU 460 are stored in semantic code table 456. Complex grammatical production rules are stored in a production rule table (PRT) 454. Production rule (PR) codes 453 for retrieving those production rules are stored in a parser table (PT) 452. The PR codes 453 in parser table 452 also allow DXP 450 to detect whether, for a given production rule, a code segment from semantic code table 456 should be loaded and executed by SPU 460.

The production rule (PR) codes 453 in parser table 452 point to production rules in production rule table 454. PR are stored, e.g., in a row-column format or a content-addressable format. In a row-column format, the rows of the table are indexed by a non-terminal symbol NT on the top of the internal parser stack, and the columns of the table are indexed by an input data value (or values) DI at the head of the input. In a content-addressable format, a concatenation of the non-terminal symbol NT and the input data value (or values) DI can provide the input to the parser table 452. Preferably, semantic processor 400 implements a content-addressable format, where DXP 450 concatenates the non-terminal symbol NT with 8 bytes of current input data DI to provide the input to the parser table 452. Optionally, parser table 452 concatenates the non-terminal symbol NT and 8 bytes of current input data DI received from DXP-450.

Input buffer 430 includes a recirculation buffer 432 to buffer data steams requiring additional passes through the DXP 450. DXP 450 parses data streams from recirculation buffer 432 similarly to those received through input port 410 or PCI bus 482.

The semantic processor 400 includes a memory subsystem 470 for storing or augmenting segments of the packets. When prompted by the DXP 450 in response the parsing of packet headers, the SPU 460 may sequence TCP packets and/or collect and assemble IP fragmented packets within memory subsystem 470. The memory subsystem 470 may also perform cryptography operations on data streams, including encryption, decryption, and authentication, when directed by SPU 450. Once reassembled and/or processed in the memory subsystem 470, the packets or their headers with a specialized NT symbol may be sent to the recirculation buffer 432 for additional parsing by DXP 450.

In certain state-dependent protocols, such as TCP, the reception order of packets gives rise to semantics that may be exploited by this semantic processing architecture. For instance, the reception of a TCP SYN packet indicates to the DXP 450 an attempt to establish a TCP session, however if the session has already been established there is no further need to allocate resources to complete the processing of the packet, acknowledge its arrival, or maintain corresponding state information. Thus any TCP packet may be correct syntactically, but out-of-sequence with regard to the state of the TCP session. The semantic processor 400 recognizes these packet-ordering semantics and implements a TCP state machine, such as 212 or 222 in FIG. 3, for managing the required TCP interactions and maintaining the state information for TCP sessions.

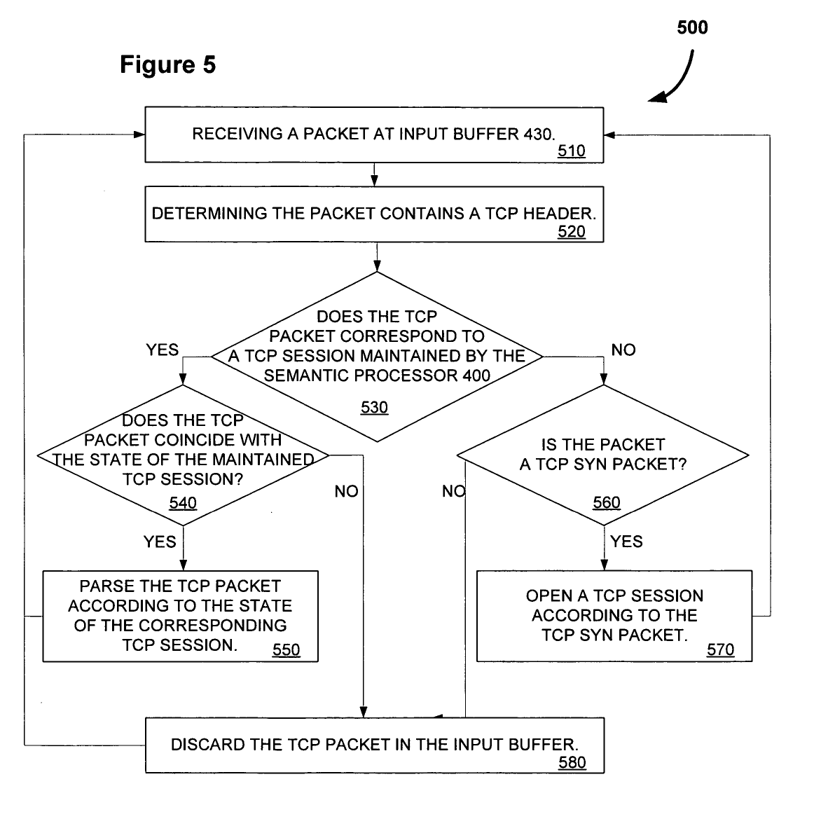

FIG. 5 shows an example flow chart 500 illustrating embodiments for operating the semantic processor 400 shown in FIG. 4 as a TCP state machine. Referring to FIG. 5, the semantic processor 400 receives a packet at input buffer 430 (at block 510) and determines the packet contains a TCP header (at block 520). The semantic processor 400 determines the presence of the TCP header by parsing through the received packet's lower level headers with DXP 450.

In a next decision block 530, the semantic processor 400 determines whether the received TCP packet corresponds to a TCP session maintained by semantic processor 400. The memory subsystem 470 maintains information for each active TCP session with semantic processor 400, including the current state of the session, packet sequencing, and window sizing. The SPU 460, when directed by the DXP 450, performs a lookup within memory subsystem 470 for a maintained TCP session that corresponds to the received TCP packet.

When a TCP session corresponding to the TCP packet is maintained within semantic processor 400, in a next decision block 540, the semantic processor 400 determines whether the TCP packet coincides with the current state of the TCP session. The SPU 460 may retrieve the state of the maintained TCP session, e.g., one or more non-terminal (NT) symbols, for the DXP 450. These NT symbols point to specialized grammatical production rules that correspond to each of the TCP states and control how the DXP 450 parses the TCP packet.

For instance, when the TCP packet is a SYN packet and its corresponding TCP session is already established, the TCP SYN packet does not coincide with the state of the TCP session and thus is discarded (at block 580) without further processing. Alternatively, when the TCP packet is a TCP data packet or a TCP FIN packet in an already established TCP session, the DXP 450 parses the packet according to the state of the TCP session in a next block 550.

Upon completion of parsing by the DXP 450, the SPU 460 may forward the 5 TCP packet to the destination address for a networking device 140, or send the payload to another semantic processor 400 where it is provided to the networking device 140 in a local session 124. The SPU 460 performs any reassembly or cryptography operations, including decryption and/or authentication, before forwarding the packets in the TCP session to the networking device 140. The processed packets are provided to output buffer 440, or to PCI bus 482 via PCI-X interface 480, after the processing operations have been completed by SPU 460.

When, at decision block 530, a TCP session corresponding to the TCP packet is not maintained within semantic processor 400, in a next decision block 560, the semantic processor 400 determines whether the TCP packet is a SYN packet attempting to establish a TCP session with semantic processor 400. The DXP 450 may determine if the TCP packet is a SYN packet by parsing the SYN flag in the TCP header.

When the TCP packet is not a SYN packet, in the next block 580, the semantic processor 400 discards the packet from the input buffer 430. The SPU 460 may 20 discard the packet from the input buffer 430 when directed by DXP 450.

When the TCP packet is a SYN packet, in a next block 570, the semantic processor 400 open a TCP session according to the TCP SYN packet. The SPU 460, when directed by DXP 450, executes microinstructions from semantic code table 456 that cause the SPU 460 to open a TCP session. The SPU 460 may open the TCP session by sending a TCP ACK message back to the source address identified by the TCP SYN packet and by allocating a context control block within memory subsystem 470 for maintaining information, including the state of the session, and packet sequencing and window sizing information. Execution then returns to block 510, where semantic processor 400 receives subsequent packets at input buffer 430, and the DXP 450 parses the subsequent packets corresponding to the established TCP session.

One of ordinary skill in the art will recognize that the concepts taught herein can be tailored to a particular application in many other advantageous ways. In particular, those skilled in the art will recognize that the illustrated embodiments are but one of many alternative implementations that will become apparent upon reading this disclosure.

The preceding embodiments are exemplary. Although the specification may refer to “an”, “one”, “another”, or “some” embodiment(s) in several locations, this does not necessarily mean that each such reference is to the same embodiment(s), or that the feature only applies to a single embodiment.

What is claimed is:

1. A system comprising:
a proxy configured to manage a plurality of sessions including at least one transmission control protocol (TCP) session, wherein the proxy translates data between the transmission control protocol session and a local session.

2. The system of claim 1 wherein the proxy operates:
a device-interface proxy configured to manage the local session with a networking device; and
a network-interface proxy configured to manage the transmission control protocol session over a public network, wherein the network-interface proxy depacketizes and sequences the data received over the transmission control protocol session prior to providing it to the device-interface proxy.

3. The system of claim 1 wherein the proxy includes at least one semantic processor having a direct execution parser to identify the transmission control protocol sessions according to a stored grammar.

4. The system of claim 3 wherein the semantic processor implements a transmission control protocol state machine to manage the transmission control protocol sessions by switching contexts within the stored grammar.

5. The system of claim 1 wherein the proxy sequences the data received out-of-order from one of the sessions during the translation.

6. The system of claim 1 wherein the proxy reassembles fragmented data from one of the sessions during the translation.

7. The system of claim 1 wherein the proxy performs cryptography operations including encryption, decryption, or authentication on the data during the translation.

8. The system of claim 1 wherein the transmission control protocol session has an endpoint signature corresponding to the proxy.

9. The system of claim 1 wherein the proxy provides the data to the networking device in the local session at a controlled rate.

10. The system of claim 9 wherein the local session is a transmission control protocol session.

11. The system of claim 1 including a plurality of networking devices each configured to process data from the network, wherein the proxy is coupled between the network and the network devices and configured to manage at least one local session with each networking device and to translate data between each local session and the corresponding transmission control protocol session.

12. The system of claim 1 wherein the proxy determines a change in the network during one of the transmission control protocol sessions and applies the network change to all of the transmission control protocol sessions over the network.

13. A method comprising:
establishing a public transmission control protocol (TCP) session for exchanging packetized data over a network;
establishing a local TCP session for exchanging data with a networking device; and
translating between the public transmission control protocol session and the local TCP session.

14. The method of claim 13 includes depacketizing the data received over the transmission control protocol session during the translating.

15. The method of claim 14 wherein depacketizing includes reassembly of fragmented data during transmission over the network.

16. The method of claim 14 wherein depacketizing includes performance of cryptography operations, including encryption, decryption, or authentication, during transmission over the network.

17. The method of claim 13 includes sequencing the data received over the transmission control protocol session during the translating.

18. A system comprising:
a first semantic processor configured to manage one or more transmission control protocol sessions over a public network; and
a second semantic processor coupled to the first semantic processor and configured to manage one or more local sessions, wherein the first and second semantic processors translate data between the transmission control protocol sessions and the local sessions.

19. The system of claim 18 wherein the first semantic processor depacketizes and sequences data received over the transmission control protocol sessions prior to providing it to the second semantic processor for transmission over corresponding local sessions.

20. The system of claim 19 wherein the first semantic processor sequences the data received out-of-order from one of the transmission protocol sessions.

21. The system of claim 19 wherein the first semantic processor reassembles fragmented data from one of the transmission protocol sessions.

22. The system of claim 19 wherein the first semantic processor performs cryptography operations including encryption, decryption, or authentication on the data from one of the transmission protocol sessions.

23. The system of claim 18 wherein the transmission control protocol sessions have an endpoint signature corresponding to the first semantic processor.

24. The system of claim 18 where the first and second semantic processors each include:
a session interface to exchange data in one or more sessions;
a semantic processor interface to exchange data with other semantic processors;
a direct execution parser to parse data received at either interface according to a stored grammar; and
at least one semantic processing unit to perform data operations when prompted by the direct execution parser.

25. The system of claim 24 wherein the first semantic processor manages the transmission control protocol sessions by switching contexts within the stored grammar.

26. The system of claim 24
wherein the local sessions are transmission control protocol sessions; and
wherein the second semantic processor manages the local sessions by switching contexts within the stored grammar.

27. The system of claim 18 wherein the first semantic processor determines a change in the network during one of the transmission control protocol sessions and applies the network change to all of the transmission control protocol sessions over the network.
